(19) United States
(12) Patent Application Publication
(10) Pub. No.: US 2017/0019300 A1
(43) Pub. Date: Jan. 19, 2017

(54) METHOD AND SYSTEM FOR AUTO DISTRIBUTION OF WORKLOAD AMONG A PLURALITY OF SERVERS WHICH RUN WEB SERVICES

(71) Applicant: SENAO NETWORKS, INC., New Taipei City (TW)

(72) Inventors: Kuan-Lin CHIU, New Taipei City (TW); Fang-Fu TSENG, New Taipei City (TW); Hui-Ju HUANG, New Taipei City (TW)

(21) Appl. No.: 15/206,504

(22) Filed: Jul. 11, 2016

(30) Foreign Application Priority Data
Jul. 13, 2015 (TW) 104122574

(51) Int. Cl. H04L 12/24; H04L 29/08

(52) U.S. Cl. CPC H04L 41/0816; H04L 67/02; H04L 41/147

(57) ABSTRACT

A method for distributing workload among a plurality of servers each having a given workload capacity for providing a web service is provided. The method is to be implemented by a master module and includes the steps of: a) for each of the servers, determining a maximum allowable workload that is smaller than the given workload capacity; b) for each of activated one(s) of the servers operating to provide the web service, detecting a current network workload thereof; c) calculating an overall workload equal to a summation of the current network workload(s) detected in step b); and d) deactivating/activating at least one of the servers so as to adjust a number of the activated one(s) of the servers according to the overall workload calculated in step c), the current network workload(s) detected in step b), and the maximum allowable workload(s) of the activated one(s) of the servers.

### CROSS-REFERENCE TO RELATED APPLICATION

This application claims priority to Taiwanese Application No. 104122574 filed on Jul. 13, 2015.

### FIELD

The disclosure relates to a method for distributing workload among a plurality of computer servers providing web services, more particularly, to an auto-scaling method for automatically distributing workload among a plurality of servers providing web services.

### BACKGROUND

In the field of web computing service, a conventional method for service providers (or system operators) is to dedicate or reserve a specific number of servers resources to deal with the entirety of the incoming network traffic. In order to determine the needed amount of server resources, it is necessary for the system operator to predict the growth trend of the incoming network traffic, which is a relatively difficult task considering the varying traffic load at different times and in different regions. To give an example, a web server may encounter workload bursts in which the traffic surges far beyond its normal volume. If insufficient servers resources are available, this may overload the systems and cause data packets to be lost. However, it may be wasteful to dedicate in advance an amount of server resources sufficient to accommodate peak traffic load because this would lead to certain amounts of server resources sitting idle and not being used during times of non-peak traffic.

### SUMMARY

An object of the disclosure is to provide a method for distributing workload among a plurality of servers to improve the cost effectiveness of operations while maintaining a reliable web service.

Another object of the disclosure is to provide a system for distributing workload among a plurality of servers to improve the cost-effectiveness of operations while maintaining a reliable web service.

Yet another object of the disclosure is to provide a server to be used in a web service in which the workload of the server is distributed in a cost-effective and reliable fashion.

This disclosure proposes a method for distributing workload among a plurality of servers each having a given workload capacity to process incoming workload. Each of the servers has a maximum allowable workload that is smaller than the given workload capacity.

In one embodiment, the method includes the steps of:

a) for each of activated ones) of the servers operating to provide the web service, detecting a current network workload thereof;

b) calculating an overall workload that is equal to a summation of the current network workload(s) detected in step a); and

c) deactivating/activating at least one of the servers so as to adjust a number of the activated one(s) of the servers according to the overall workload calculated in step b), the current network workload(s) detected in step a), and the maximum allowable workload(s) of the activated one(s) of the servers.

With the setting of the maximum allowable workloads of the servers, the method can estimate the status of each activated server and determine whether to increase or decrease the total number of activated server(s).

In one embodiment, a system for distributing workload includes a plurality of servers and a master module. Each of the servers has a given workload capacity for providing a web service and a maximum allowable workload that is smaller than the given workload. The master module is for distributing workload among the servers, and is configured to detect a current network workload for each of activated one(s) of the servers operating to provide the web service, and calculate an overall workload equal to a summation of the current network workload(s) detected thereby, and deactivate/activate at least one of the servers so as to adjust a number of the activated one(s) of the servers according to the overall workload, the current network workload(s), and the maximum allowable workload(s) of the activated one (s) of the servers.

### BRIEF DESCRIPTION OF THE DRAWINGS

Other features and advantages of the disclosure will become apparent in the following detailed description of the embodiment with reference to the accompanying drawings, of which:

FIG. 1 is a flow chart of a method for distributing workload among a plurality of servers according to an embodiment of the present disclosure;

FIG. 2 is a schematic diagram of a master module implementing the method of the embodiment and distributing workload of one server to two servers;

FIG. 3 is another schematic diagram similar to FIG. 2 and illustrating the master module deactivating one of the servers; and

FIG. 4 is a schematic diagram of a system for distributing workload among a plurality of servers thereof according to the embodiment of the present disclosure.

### DETAILED DESCRIPTION

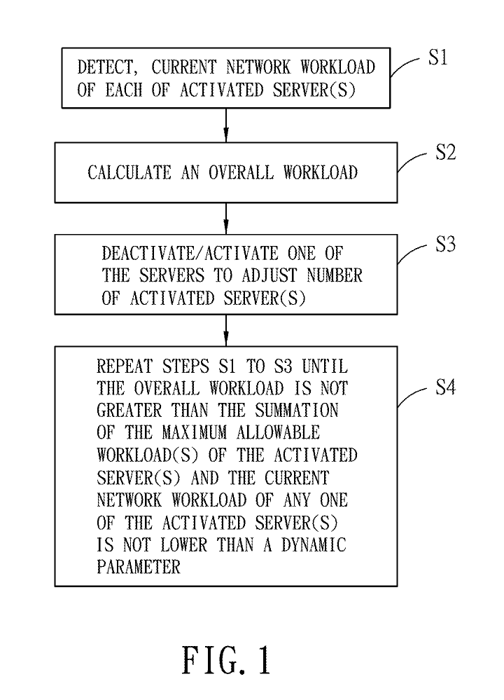

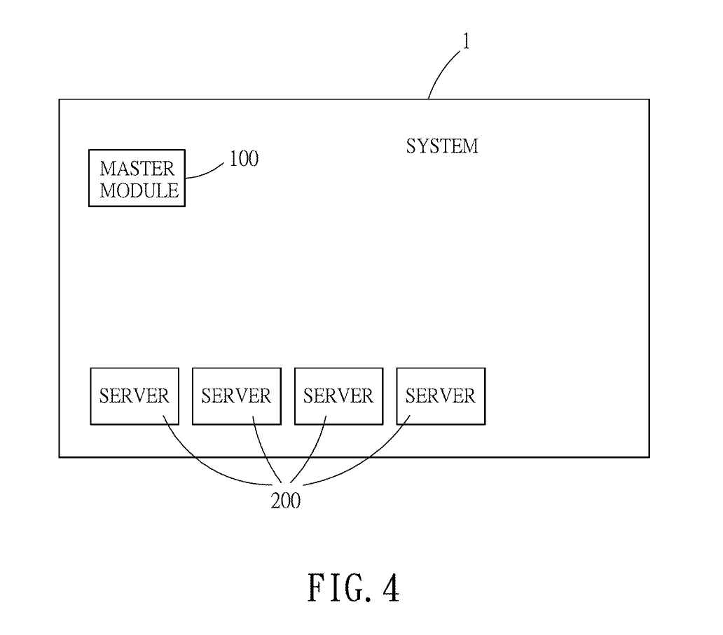

Referring to FIGS. 1 and 4, a method for distributing workload among a plurality of servers 200 of a system 1 according to the embodiment of this disclosure is implemented by a master module 100 of the system 1. Each of the servers 200 has a given workload capacity for providing a web service. Each of the servers 200 has a maximum allowable workload that is smaller than the given workload capacity and a minimum workload that is smaller than the maximum allowable workload. It should be noted that the maximum allowable workloads and the minimum workloads of the servers 200 are independent from each other. Further, the maximum allowable workload is a factor that the corresponding server 200 can operate reliably and may be determined by the master module 100 or provided by a third party.

In step S1, the master module 100 detects, for each of activated one(s) of the servers 200 operating to provide the web service, a current network workload thereof.

In step S2, the master module 100 calculates an overall workload equal to a summation of the current network workload(s) detected in step S1.

In step S3, the master module 100 deactivates/activates one of the servers 200 so as to adjusts a number of the activated one(s) of the servers 200 according to the overall workload calculated in step S2, the current network workload(s) detected in step S1, and the maximum allowable workload(s) of the activated one(s) of the servers 200.

Specifically, the master module 100 activates one of the servers 200 other than the activated one(s) to provide the web service when the overall workload is greater than a summation of the maximum allowable workload(s) of the activated one(s) of the servers 200.

In addition, when the number of the activated one(s) of the servers 200 is greater than one (i.e., there are a plurality of the activated ones of the servers), the master module 100 deactivates a selected one of the activated ones of the servers 200 when the current network workload of any one of the activated ones of the servers 200 is lower than a dynamic parameter that is associated with the current network workloads of the activated ones of the servers 200 (to be defined in the following). In one embodiment, the master module 100 deactivates said selected one of the activated ones of the servers 200 when the current network workload of any one of the activated ones of the servers 200 is lower than the dynamic parameter and remains lower than the dynamic parameter for a predetermined duration. In one embodiment, the master module 100 selects one of the activated ones of the servers 200 whose current network workload is lower than a residual workload capacity (to be defined in the following) as the selected one of the servers 200. In one embodiment, the master module 100 selects one of the activated ones of the servers 200 whose current network workload is the smallest among the activated ones of the servers 200 as said selected one of the servers 200 to be deactivated. The conditions for selecting said selected one of the servers 200 to be deactivated may be combinable where feasible. The mater module 100 then deactivates the selected one of the servers 200, and distributes the current network workload of said selected one of the servers 200 to remaining one(s) of the activated ones of the servers 200.

The dynamic parameter is defined as an average of the current network workloads of the activated ones of the servers 200 and is periodically updated as desired. The residual workload capacity is a difference between a summation of the current network workload(s) of the remaining one(s) of the activated ones of the servers 200 and a summation of the maximum allowable workload(s) of the remaining one(s).

It should be noted that the master module 100 may distribute the current network workload of said selected one of the servers 200 to the remaining one(s) of the activated ones of the servers 200 by one of equal distribution and weighted distribution. Since the main feature of this disclosure does not reside in equal distribution and weighted distribution, details of the same are omitted for the sake of brevity.

In step S4, the master module 100 repeats steps S1 to S3 until the overall workload is not greater than the summation of the maximum allowable workloads of the activated one(s) of the servers 200 and the current network workload of any one of the activated one(s) of the servers 200 is not lower than the dynamic parameter.

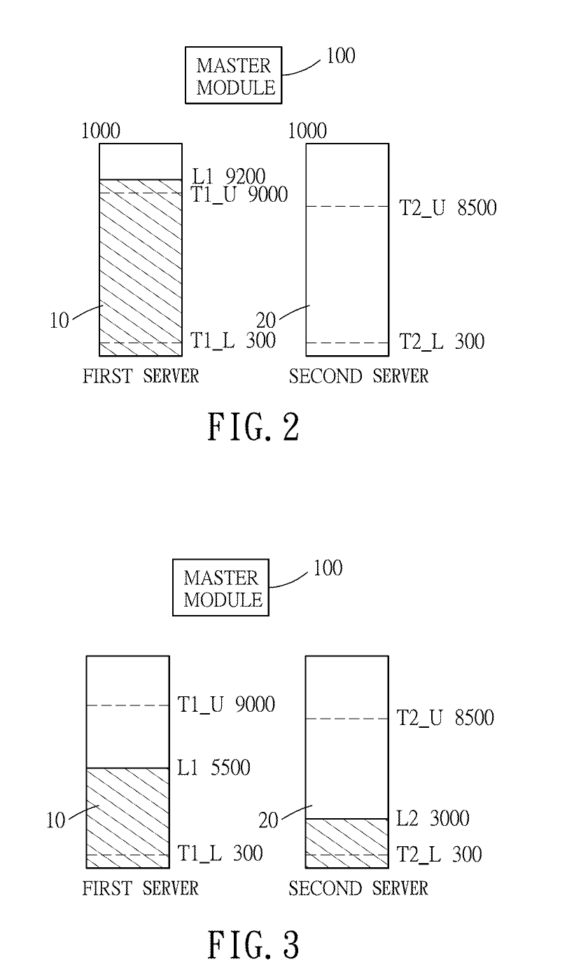

FIG. 2 illustrates an example of the master module 100 implementing the method of the present disclosure and distributing workload between first and second servers 10, 20. In this example, the given workload capacity of each of the first and second servers 10, is defined as a maximum number of permitted connections to the first/second server 10, 20, and is for example, 10000. The master module 100 determines the maximum allowable workloads (T1_U, T2_U) of the first and second servers 10, 20 as 9000 and 8500, respectively, and the minimum workloads (T1_L, T2_L) of the first and second servers 10, 20 as both 300. Generally, to maintain operation reliability of the first and second servers 10, 20, the maximum allowable workload is smaller than the given workload capacity.

In this example, the first server 10 is an activated server and is operating to provide the web service and the second server 20 is in a power-saving mode such as a sleep mode and a turned-off mode and does not provide the web service (i.e., deactivated). The master module 100 detects a current network workload (L1) of the first server 10 as 9200. At this time, since the second server 20 does not provide the web service, the overall workload is equal to the current network workload (L1) of 9200 of the first server 10 as determined by the master module 100, which is greater than the summation of the maximum allowable workload of the activated server, i.e., the maximum allowable workload (T1_U) of 9000 of the first server 10. In view of this, the master module 100 activates the second server 20, which is not previously activated, to provide the web service. By this way, the current network workload of the first server 10 may be shared by the second server 20 and be decreased below its maximum allowable workloads (T1_U) of 9000. It should be noted that the number of the servers may vary in other embodiments of this disclosure.

Referring to FIG. 3, in another example of the master module 100 implementing the method of the present disclosure to decrease the number of activated servers is illustrated. In this example, the maximum allowable workloads (T1_U, T2_U) of first and second servers 10, 20 are 9000 and 8500, respectively. The master module 100 detects the current network workload (L1, L2) of the first and second servers 10, 20 to be 5500 and 3000, respectively. The overall workload is a summation of (L1) and (L2), i.e., 8500. The master module 100 detects that the current network workload (L2) of 3000 of the second server 20 is lower than a dynamic parameter obtained from the equation of (L1+L2)/2 of 4250, and that the current network workload (L2) of the second server 20 remains lower than the dynamic parameter for a predetermined duration of, e.g., 300 seconds. In addition, the master module 100 determines that the current network workload (L2) of 3000 of the second server 20 is lower than a residual workload capacity (herein, a residual workload capacity of the first server 10), which can be obtained from the equation of (T1_U)−(L1) as 7500. Therefore, the master module 100 selects the second server 20 as the selected one of the servers to be deactivated. The master module 100 distributes the current network workload (L2) of the second server 20 to the first server 10 and deactivates the second server 20 to the power-saving mode so as not to provide the web service.

It should be noted that the master module 100 may be one of the servers and may alternatively be an electronic device without web service functionality such as a virtual machine, and the disclosure is not limited to this aspect.

To sum up, in this disclosure, the method to be implemented by the master module 100 is capable of detecting the current network workloads of the activated server(s) and adjusting the number of the activated server(s) according to the overall workload, the dynamic parameter, and the maximum allowable workloads of the activated server(s) periodically or in real-time. Thus, the present disclosure can achieve a relative low operation cost while maintaining a reliable web service.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for distributing workload among a plurality of servers each having a given workload capacity for providing a web service, each of the servers having a maximum allowable workload that is smaller than the given workload capacity, the method to be implemented by a master module and comprising the steps of:
a) for each of activated one(s) of the servers operating to provide the web service, detecting a current network workload thereof;
b) calculating an overall workload equal to a summation of the current network workload(s) detected in step a); and
c) deactivating/activating at least one of the servers so as to adjust a number of the activated one(s) of the servers according to the overall workload calculated in step b), the current network workload(s) detected in step a), and the maximum allowable workload(s) of the activated one(s) of the servers.

2. The method of claim 1, wherein, in step c), the master module activates one of the servers other than the activated one(s) to provide the web service when the overall workload is greater than a summation of the maximum allowable workload(s) of the activated one(s) of the servers.

3. The method of claim 2, wherein, in step c), when the number of the activated one(s) of the servers is greater than one, the master module deactivates a selected one of the activated ones of the servers when the current network workload of any one of the activated ones of the servers is lower than a dynamic parameter that is associated with the current network workloads of the activated ones of the servers.

4. The method of claim 3, wherein the master module deactivates said selected one of the activated ones of the servers when the current network workload of any one of the activated ones of the servers is lower than the dynamic parameter for a predetermined duration.

5. The method of claim 3, wherein, in step c), the master module selects one of the activated ones of the servers the current network workload of which is lower than a residual workload capacity as said selected one, deactivates said selected one, and distributes the current network workload of said selected one to remaining one(s) the activated ones of the servers, the residual workload capacity being a difference between a summation of the current network workload(s) of the remaining one(s) of the activated ones of the servers and a summation of the maximum allowable workload(s) of the remaining one(s).

6. The method of claim 5, further comprising the step of repeating steps a) to c) until the overall workload is not greater than the summation of the maximum allowable workload(s) of the activated one(s) of the servers and the current network workload of any one of the activated one(s) of servers is not lower than the dynamic parameter.

7. The method of claim 5, wherein the master module distributes the current network workload of said selected one of the servers to the remaining one(s) of the activated ones of the servers by one of equal distribution and weighted distribution.

8. The method of claim 3, wherein, in step d), the master module selects one of the activated ones of the servers the current network workload of which is the smallest among the activated ones of the servers as said selected one, deactivates the selected one, and distributes the current network workload of said selected one to remaining one(s) the activated ones of the servers.

9. The method of claim 8, further comprising the step of repeating steps a) to c) until the overall workload is not greater than the summation of the maximum allowable workload(s) of the activated one(s) of the servers and the current network workload of any one of the activated one(s) of the servers is not lower than the dynamic parameter.

10. The method of claim 8, wherein the master module distributes the current network workload of said selected one of the servers to the remaining one(s) of the activated one(s) of the servers by one of equal distribution and weighted distribution.

11. The method of claim 3, wherein the dynamic parameter is an average of the current network workloads of the activated ones of the servers.

12. A system for distributing workload, comprising:
a plurality of servers each having a given workload capacity for providing a web service and a maximum allowable workload that is smaller than the given workload; and
a master module for distributing workload among said servers, and configured to detect a current network workload for each of activated one(s) of said servers operating to provide the web service, and calculate an overall workload equal to a summation of the current network workload(s) detected thereby, and deactivate/activate at least one of said servers so as to adjust a number of the activated one(s) of the servers according to the overall workload, the current network workload(s), and the maximum allowable workload(s) of the activated one(s) of said servers.

13. The system as claimed in claim 12, wherein said master module is further configured to activate one of said servers other than the activated one(s) to provide the web service when the overall workload is greater than a summation of the maximum allowable workload(s) of the activated one(s) of said servers.

14. The system as claimed in claim 13, wherein said master module is further configured to deactivate, when the number of the activated one(s) of said servers is greater than one, a selected one of the activated ones of said servers when the current network workload of any one of the activated ones of said servers is lower than a dynamic parameter that is associated with the current network workloads of the activated ones of said servers.

15. The system as claimed in claim 14, wherein said master module is further configured to deactivate said selected one of the activated ones of said servers when the current network workload of any one of the activated ones of said servers is lower than the dynamic parameter for a predetermined duration.

16. The system as claimed in claim 14, wherein said master module is further configured to select one of the activated ones of said servers the current network workload of which is lower than a residual workload capacity as said selected one, deactivate said selected one, and distribute the current network workload of said selected one to remaining one(s) the activated ones of said servers, the residual workload capacity being a difference between a summation of the current network workload(s) of the remaining one(s) of the activated ones of said servers and a summation of the maximum allowable workload(s) of the remaining one(s).

17. The method of claim 16, wherein said master module is further configured to distribute the current network workload of said selected one of said servers to the remaining one(s) of the activated ones of said servers by one of equal distribution and weighted distribution.

18. The system of claim 14, wherein said master module is further configured to select one of the activated ones of said servers the current network workload of which is the smallest among the activated ones of said servers as said selected one, deactivate the selected one, and distribute the current network workload of said selected one to remaining one(s) the activated ones of said servers.

19. The system of claim 18, wherein said master module is further configured to distribute the current network workload of said selected one of said servers to the remaining one(s) of the activated one(s) of said servers by one of equal distribution and weighted distribution.

20. The system of claim 14, wherein the dynamic parameter is an average of the current network workloads of the activated ones of said servers.
